(19) United States
(12) Patent Application Publication
(10) Pub. No.: US 2025/0284300 A1
(43) Pub. Date: Sep. 11, 2025

(54) INTERNET OF THINGS (IOT) SYSTEMS, METHODS, AND STORAGE MEDIA FOR SMART GAS PIPELINE PRESSURE DIFFERENCE SAFETY MONITORING

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Jun WANG, Chengdu (CN); Feng WANG, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/218,226

(22) Filed: May 24, 2025

(30) Foreign Application Priority Data
Apr. 14, 2025 (CN) 202510458635.4

(51) Int. Cl. G05D 16/00; G01F 23/00; G16Y 40/35; G16Y 40/50

(52) U.S. Cl. CPC G05D 16/028; G01F 23/0007; G16Y 40/35; G16Y 40/50

(57) ABSTRACT

Provide are an IoT system, a method, and a storage medium for smart gas pipeline pressure difference safety monitoring. A gas company management platform of the IoT system is configured to: obtain a pressure difference data matrix of a current gas pipeline network from a gas equipment object platform; determine an abnormality judgment result for the current gas pipeline network based on the pressure difference data matrix; in response to determining that the abnormality judgment result indicates an abnormality, determine an abnormality probability distribution of the current gas pipeline network based on the pressure difference data matrix; generate an operation instruction set based on the abnormality probability distribution; generate a pressure adjustment instruction based on the pressure difference data matrix, and send the pressure adjustment instruction to the gas equipment object platform to control a pressure adjustment device to regulate an abnormal gas pipeline in the current gas pipeline network.

### CROSS-REFERENCE TO RELATED APPLICATIONS

This application claims priority to Chinese Patent Application No. 202510458635.4, filed on Apr. 14, 2025, the entire content of each of which is hereby incorporated by reference.

### TECHNICAL FIELD

The present disclosure relates to the field of pipeline monitoring, and particularly relates to an Internet of Things (IoT) system, a method, and a storage medium for smart gas pipeline pressure difference safety monitoring.

### BACKGROUND

As critical infrastructure for modern energy transportation, gas pipelines undertake the important task of efficiently delivering natural gas. Monitoring pressure variations in gas pipelines is essential for safety assessment of gas pipeline networks. Abnormal pressure differences between different gas pipelines at a same time or within a same pipeline at different times may indicate potential issues such as gas leaks.

Currently, there are various manners (e.g., using a pressure sensor) for monitoring pressure differences. However, effective approaches for determining whether pressure differences are abnormal and for determining underlying causes remain lacking.

Therefore, it is desirable to provide an IoT system, a method, and a storage medium for smart gas pipeline pressure difference safety monitoring that enables real-time and accurate monitoring and analysis of gas pipeline pressure differences, ensuring safe and stable operation of gas pipeline networks while maintaining continuity and reliability of energy supply.

### SUMMARY

To address issues including abnormal pressure difference analysis and pressure root cause determination, the present disclosure provides an IoT system, a method, and a storage medium for smart gas pipeline pressure difference safety monitoring.

One or more embodiments of the present disclosure provide an Internet of Things (IoT) system for smart gas pipeline pressure difference safety monitoring. The IoT system comprises a government safety supervision management platform, a government safety supervision sensor network platform, a government safety supervision object platform, a gas company sensor network platform, a gas equipment object platform, and a gas maintenance object platform. The government safety supervision object platform includes a gas company management platform. The gas company management platform is configured to implement a method for smart gas pipeline pressure difference safety monitoring.

One or more embodiments of the present disclosure provide a method for smart gas pipeline pressure difference safety monitoring. The method comprises obtaining a pressure difference data matrix of a current gas pipeline network from a gas equipment object platform, wherein the pressure difference data matrix includes pressure difference data of gas pipelines in the current gas pipeline network during different time periods. The method further comprises determining an abnormality judgment result for the current gas pipeline network based on the pressure difference data matrix; in response to determining that the abnormality judgment result indicates an abnormality, determining an abnormality probability distribution of the current gas pipeline network based on the pressure difference data matrix; and generating an operation instruction set based on the abnormality probability distribution, wherein the operation instruction set includes operation instructions corresponding to the gas pipelines in the current gas pipeline network, and the operation instructions include at least one of a monitoring regulation instruction, a motion control instruction, a reporting instruction, and a maintenance instruction. The monitoring regulation instruction is sent to the gas equipment object platform to adjust a monitoring frequency of a pipeline monitoring device, the motion control instructions is sent to the gas equipment object platform to instruct a pipeline inspection device to inspect one or more target gas pipelines at a preset frequency, the reporting instruction is sent to a government safety supervision management platform to receive and record an abnormal condition of the current gas pipeline network, and the maintenance instruction is sent to a gas maintenance object platform to dispatch maintenance personnel to perform maintenance on the current gas pipeline network. The method further comprises generating a pressure adjustment instruction based on the pressure difference data matrix, and sending the pressure adjustment instruction to the gas equipment object platform to control a pressure adjustment device to regulate an abnormal gas pipeline in the current gas pipeline network.

One or more embodiments of the present disclosure provide a non-transitory computer-readable storage medium storing computer instructions, wherein when a computer reads the computer instructions from the storage medium, the computer executes the method for smart gas pipeline pressure difference safety monitoring described in the present disclosure.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering denotes the same structure, wherein:

FIG. 1 is a schematic diagram illustrating an exemplary platform structure of an IoT system for smart gas pipeline pressure difference safety monitoring according to some embodiments of the present disclosure;

FIG. 2 is a flowchart illustrating an exemplary process of a method for smart gas pipeline pressure difference safety monitoring according to some embodiments of the present disclosure;

FIG. 3 is a flowchart illustrating an exemplary process for determining an abnormality probability distribution according to some embodiments of the present disclosure;

FIG. 4 is a flowchart illustrating an exemplary process for determining an operation instruction set according to some embodiments of the present disclosure; and

FIG. 5 is schematic diagram of an exemplary evaluation model according to some embodiments of the present disclosure.

### DETAILED DESCRIPTION

The accompanying drawings, which are required to be used in the description of the embodiments, are briefly described below. The accompanying drawings do not represent the entirety of the embodiments.

When describing operations performed step-by-step in the embodiments of the present disclosure, unless otherwise specified, the order of the operations may be adjusted, operations may be omitted, and additional steps may be included in the processes. The term “and/or” used in the present disclosure indicated that a feature, component, device, etc., includes one or more of the associated listed items.

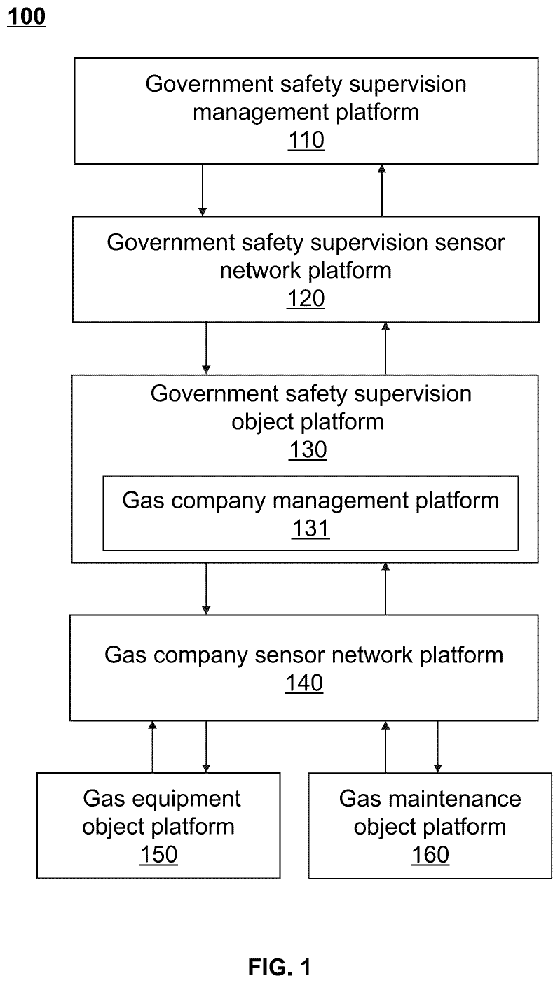

FIG. 1 is a schematic diagram illustrating an exemplary platform structure of an IoT system for smart gas pipeline pressure difference safety monitoring according to some embodiments of the present disclosure.

In some embodiments, as shown in FIG. 1, an IoT system 100 for smart gas pipeline pressure difference safety monitoring (hereinafter referred to as the IoT system 100) may include a government safety supervision management platform 110, a government safety supervision sensor network platform 120, a government safety supervision object platform 130, a gas company sensor network platform 140, a gas equipment object platform 150, and a gas maintenance object platform 160.

The government safety supervision management platform 110 refers to a platform for supervising and managing the safety of a gas pipeline network. The government safety supervision management platform 110 coordinates connections and collaborations between functional platforms and provides perception management and control management functions for the operation of the IoT system 100.

The government safety supervision sensor network platform 120 refers to a platform for managing sensor communications for government entities and may be configured as a communication network or a gateway.

In some embodiments, the government safety supervision sensor network platform 120 interacts upward with the government safety supervision management platform 110 and downward with the government safety supervision object platform 130. For example, the government safety supervision object platform 130 may send a reporting instruction to the government safety supervision management platform 110 through the government safety supervision sensor network platform 120.

The government safety supervision object platform 130 refers to an object platform for generating sensing information and executing control information.

In some embodiments, the government safety supervision object platform 130 may include a gas company management platform 131.

The gas company management platform 131 refers to a comprehensive management platform for gas company-related information, configured to manage parameters related to gas pipeline pressure difference safety monitoring.

In some embodiments, the gas company management platform 131 may further include a processor. The processor may include one or more sub-processing devices (e.g., single-core or multi-core multi-chip processing devices). By way of example only, the processor may include a central processing unit (CPU), an application-specific integrated circuit (ASIC), or the like, any combination thereof.

The gas company sensor network platform 140 refers to a comprehensive management platform for gas company sensor information, which may be configured as a communication network or a gateway to enable sensing communication and control information transmission.

In some embodiments, the gas company sensor network platform 140 may interact upward with the government safety supervision object platform 130 and downward with the gas equipment object platform 150 and the gas maintenance object platform 160. For example, the government safety supervision object platform 130 may send a monitoring regulation instruction, a motion control instruction, and a pressure adjustment instruction to the gas equipment object platform 150 via the gas company sensor network platform 140, or send the reporting instruction and a maintenance instruction to the gas maintenance object platform 160.

The gas equipment object platform 150 refers to a functional platform for performing pressure difference safety monitoring, pressure difference adjustment, and pipeline inspection. The gas equipment object platform 150 may include at least one pipeline monitoring device, at least one pipeline inspection device, and at least one pressure adjustment device.

A pipeline monitoring device is a functional device for monitoring pressure differences within gas pipelines, such as a pressure sensor, or the like. In some embodiments, the pipeline monitoring device may be configured to obtain a pressure difference data matrix of the gas pipeline network.

A pipeline inspection device is a functional device for inspecting gas pipelines, such as a pipeline crawling robot, or the like. In some embodiments, the pipeline inspection device may be configured to inspect one or more target gas pipelines at a preset frequency.

The pressure adjustment device is a functional device for regulating pressure within gas pipelines, such as a gas pipeline pressure regulator, or the like. In some embodiments, the pressure adjustment device may be configured to regulate an abnormal gas pipeline in a current gas pipeline network.

The gas maintenance object platform 160 refers to a platform for interacting with gas pipeline maintenance personnel. The gas pipeline maintenance personnel refers to personnel engaged in gas pipeline network-related work, such as a safety officer, a maintenance worker, or the like.

The gas maintenance object platform 160 may include at least one interaction device, such as a mobile phone, a computer, or the like. In some embodiments, the gas maintenance object platform may receive the maintenance instruction to dispatch maintenance personnel for maintaining the current gas pipeline network.

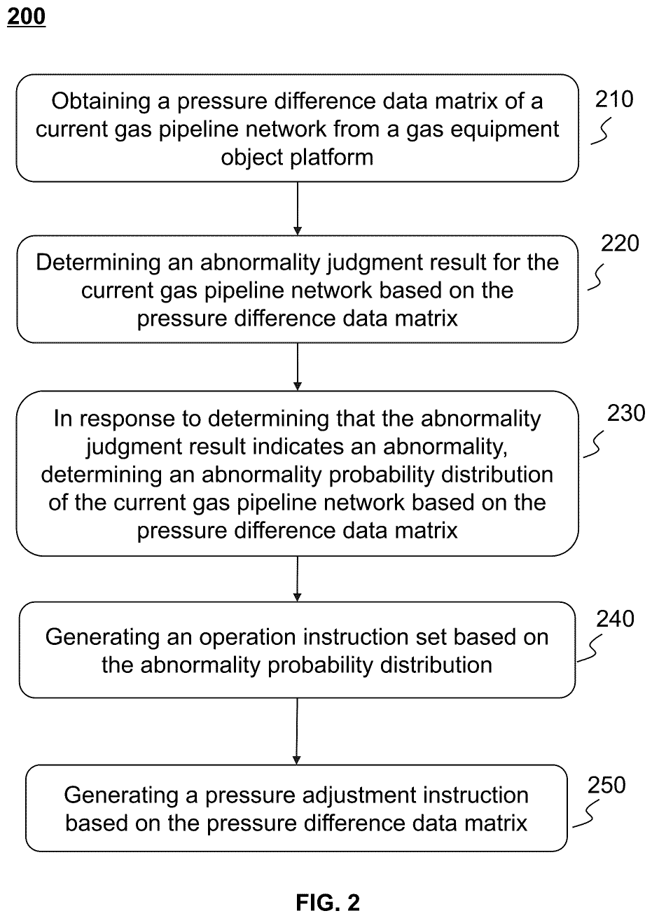

Further details about the aforementioned platforms may be found in FIGS. 2-5 and related descriptions.

In some embodiments of the present disclosure, the IoT system 100 can establish an information operation closed-loop among various functional platforms. Under the unified management of the gas company management platform, these platforms operate in a coordinated and regulated manner, achieving smart and information-based smart gas pipeline pressure difference safety monitoring.

FIG. 2 is a flowchart illustrating an exemplary process of a method for smart gas pipeline pressure difference safety monitoring according to some embodiments of the present disclosure. As shown in FIG. 2, process 200 includes the following operations. In some embodiments, process 200 may be implemented based on the IoT system 100 and executed by the gas company management platform 131, for example, by a processor within the gas company management platform 131.

For more details about the gas company management platform 131 and the processor, refer to the description related to FIG. 1.

In 210, obtaining a pressure difference data matrix of a current gas pipeline network from a gas equipment object platform.

The current gas pipeline network refers to a gas pipeline network currently requiring pressure difference safety monitoring. In some embodiments, the current gas pipeline network may include a plurality of gas pipelines.

The pressure difference data matrix is a matrix composed of pressure difference data. In some embodiments, the pressure difference data matrix may include pressure difference data of each of the plurality of gas pipelines in the current gas pipeline network during different time periods.

The different time periods may be preset by the processor or configured by a technician based on requirements. For example, the different time periods may be a plurality of time segments within 24 hours.

The pressure difference data refers to data related to pressure differences between gas pipelines. In some embodiments, gas pipeline pressure may be monitored and obtained by pipeline monitoring devices (e.g., pressure sensors).

In some embodiments, each time period may include a plurality of time points, and adjacent time points within a time period form a sub-period. For a gas pipeline, the pressure difference data during a time period refers to an average of pressure difference data of all sub-periods within the time period. The pressure difference data of a sub-period may be calculated by subtracting gas pipeline pressure at an initial time point from pressure at an ending time point of the sub-period.

In some embodiments, the processor may obtain pressure difference data of the gas pipelines in the current gas pipeline network during the different time periods from the gas equipment object platform, and construct the pressure difference data matrix by using the pressure difference data of a gas pipeline during a time period as an element of the pressure difference data matrix, arranging pressure difference data of different gas pipelines during a same time period as row vectors, and arranging pressure difference data of a same gas pipeline during different time periods as column vectors. For example, the pressure difference data matrix may be represented by

$$[ \begin{matrix}{d}_{11} & {d}_{12} & ⋯ & {d}_{1 m} \\ {d}_{21} & {d}_{22} & ⋯ & {d}_{2 m} \\ ⋮ & ⋮ & ⋱ & ⋮ \\ {d}_{n 1} & {d}_{n 2} & ⋯ & {d}_{n m}\end{matrix} ] ,$$

where m represents a count of the gas pipelines in the current gas pipeline network, n represents a count of the time periods, dⱼᵢ represents pressure difference data of a gas pipeline i during a time period j (i=1, 2, . . . , m, j=1, 2, . . . , n), row vectors (dⱼ₁, dⱼ₂, . . . , dⱼₘ) represents pressure difference data of different gas pipelines (gas pipeline 1 to gas pipeline m) during the time period j, and column vectors (d₁ᵢ, d₂ᵢ, . . . , dₙᵢ) represents pressure difference data of the gas pipeline i during different time periods (time period 1 to time period n).

In 220, determining an abnormality judgment result for the current gas pipeline network based on the pressure difference data matrix.

The abnormality judgment result indicates whether the pressure difference data of the gas pipeline network is abnormal. The abnormality judgment result may indicate an abnormality or indicate no abnormality.

In some embodiments, the processor may determine the abnormality judgment result of the gas pipeline network through a plurality of manners based on the pressure difference data matrix.

In some embodiments, in response to determining that pressure difference data exceeding a preset pressure difference threshold exists in the pressure difference data matrix, the processor may determine that the abnormality judgment result indicates an abnormality. The preset pressure difference threshold refers to a maximum value of pressure difference data when no abnormality exists, and the preset pressure difference threshold may be set by the processor by default or by a technician based on historical experience.

In some embodiments, in response to determining that a count of abnormal gas pipelines in the pressure difference data matrix exceeds a first preset threshold, the processor determines that the abnormality judgment result indicates an abnormality.

An abnormal gas pipeline refers to a gas pipeline with abnormal pressure difference data. In some embodiments, if a gas pipeline has abnormal pressure difference data during one or more time periods, the gas pipeline is identified as an abnormal gas pipeline.

In some embodiments, the abnormal pressure difference data refers to pressure difference data exceeding a normal pressure difference range. The normal pressure difference range may be determined by the processor or a technician based on historical data statistics, and the normal pressure difference ranges may be the same or different for different gas pipelines across different time periods. For example, for dⱼᵢ (pressure difference data of the gas pipeline i during the time period j), the normal pressure difference range corresponding to dⱼᵢ is determined based on a preset range size, with an average value of a plurality of pieces of historical pressure difference data of the gas pipeline i during the time period j from historical measurements taken as a range center. The preset range size may be set by the processor by default or by a technician based on historical experience. For example, if the range center is 0.1 MPa and the preset range size of ±0.05 MPa, the normal pressure difference range may be (0.05 MPa, 0.15 MPa).

The first preset threshold refers to a maximum allowable count of abnormal gas pipelines when no abnormality exists.

In some embodiments, the first preset threshold may be set by the processor by default or by a technician based on historical experience.

In some embodiments, the first preset threshold may also be related to a count of abnormality occurrences in the current gas pipeline network during a historical time period.

The historical time period refers to a time period before a current time period. If the current time period is a time period in the pressure difference data matrix, the historical time period may be a time period before the earliest time period in the pressure difference data matrix.

The count of abnormality occurrences refers to a count of instances where the abnormality judgment result of the gas pipeline network indicates an abnormality. In some embodiments, the count of abnormality occurrences in the current gas pipeline network during historical time periods may be obtained by the processor or a technician through statistical analysis of historical data.

In some embodiments, the first preset threshold may be negatively correlated with the count of abnormality occurrences. The larger the count of abnormality occurrences in the current gas pipeline network during the historical time period is, the greater instability of the current gas pipeline network is, and accordingly, the corresponding first preset threshold may be set smaller to ensure timely detection of abnormalities in the current gas pipeline network.

In some embodiments of the present disclosure, by determining whether the count of abnormal gas pipelines in the pressure difference data matrix exceeds the first preset threshold, the abnormality judgment result of the current gas pipeline network can be accurately determined, which facilitates timely detection of pipeline network abnormalities.

In 230, in response to determining that the abnormality judgment result indicates an abnormality, determining an abnormality probability distribution of the current gas pipeline network based on the pressure difference data matrix.

The abnormality probability distribution refers to a distribution of abnormal conditions in the current gas pipeline network. In some embodiments, the abnormality probability distribution may include a plurality of abnormal condition combinations in the current gas pipeline network and probabilities of occurrence corresponding to the abnormal condition combinations.

An abnormal condition refers to an abnormal event that may occur during transportation of gas in the gas pipeline network, such as a pipeline leak, a pipeline blockage, an equipment failure, or the like. An abnormal condition combination refers to a combination of a plurality of abnormal gas pipelines and their corresponding abnormal conditions.

Merely by way of example, if the current gas pipeline network includes an abnormal gas pipeline 1 and an abnormal gas pipeline 2, and the abnormal conditions include an abnormal condition 1 (e.g., a pipeline leak) and an abnormal condition 2 (e.g., a pipeline blockage), then possible abnormal condition combinations may include: W₁={(L₁, Y₁), (L₂, Y₁)}, W₂={(L₁, Y₂),(L₂, Y)}, W₃={(L₁, Y₁),(L₂, Y₂)}, W₄={(L₁, Y₂), (L₂, Y₂)}, where L₁ and L₂ represent the abnormal gas pipeline 1 and the abnormal gas pipeline 2, respectively, and Y₁ and Y₂ represent the abnormal condition 1 and the abnormal condition 2, respectively. W₁, W₂, W₃, and W₄ denote four abnormal condition combinations. W₁={(L₁, Y₁), (L₂, Y₁)} indicates that the abnormal gas pipeline 1 has the abnormal condition 1 and the abnormal gas pipeline 2 has the abnormal condition 1, with other combinations following similar logic.

Correspondingly, the abnormality probability distribution may be expressed as {P(W₁)=p₁, P(W₂)=p₂, P(W₃)=p₃, P(W₄)=p₄}, where p₁, p₂, p₃, and p₄ represent probabilities of occurrence corresponding to the abnormal condition combinations W₁, W₂, W₃, and W₄, respectively. For example, p₁ may be calculated as a product of the probability of occurrence of the abnormal condition 1 in the abnormal gas pipeline 1 and the probability of occurrence of the abnormal condition 1 in the abnormal gas pipeline 2, with other probabilities calculated similarly.

In some embodiments, the processor may determine the abnormality probability distribution in various manners based on the pressure difference data matrix. For example, the processor may determine a corresponding abnormality probability distribution by querying a first preset table that maps pressure difference data matrices to abnormality probability distributions. The first preset table may be constructed by the processor and/or a technician based on historical data.

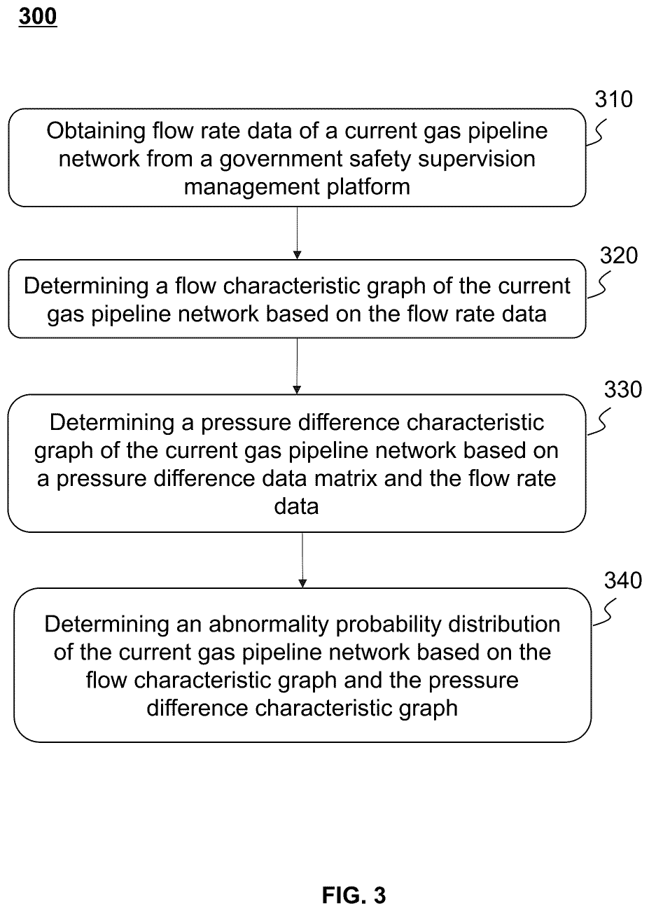

In some embodiments, the processor may be further configured to: obtain flow rate data of the current gas pipeline network from a government safety supervision management platform; determine a flow characteristic graph of the current gas pipeline network based on the flow rate data; determine a pressure difference characteristic graph of the current gas pipeline network based on the pressure difference data matrix and the flow rate data; and determine the abnormality probability distribution of the current gas pipeline network based on the flow characteristic graph and the pressure difference characteristic graph. Further details of this process are described in FIG. 3.

In 240, generating an operation instruction set based on the abnormality probability distribution.

The operation instruction set refers to a collection of operation instructions.

An operation instruction refers to a command for operational safety monitoring of a gas pipeline pressure difference. The operation instructions may include at least one of a monitoring regulation instruction, a motion control instruction, a reporting instruction, and a maintenance instruction.

The monitoring regulation instruction refers to a command for adjusting pipeline monitoring devices. The monitoring regulation instruction is sent to the gas equipment object platform to adjust a monitoring frequency of a pipeline monitoring device.

In some embodiments, the monitoring regulation instruction may further be used to add an additional pipeline monitoring device.

The motion control instruction refers to a command for controlling movements of a pipeline inspection device. The motion control instruction is sent to the gas equipment object platform to instruct the pipeline inspection device to inspect one or more target gas pipelines at a preset frequency.

A target gas pipeline refers to a gas pipeline requiring inspection. In some embodiments, the processor may determine an abnormal gas pipeline and its connected upstream and downstream gas pipelines as target gas pipelines.

The reporting instruction refers to an instruction for communicating relevant information. The reporting instruction may be sent to the government safety supervision management platform to receive and record an abnormal condition of the current gas pipeline network.

The maintenance instruction refers to an instruction for maintaining gas pipelines. The maintenance instruction may include a geographical location of an abnormal gas pipeline and an allocated count of corresponding maintenance personnel. The maintenance instruction may be sent to the gas maintenance object platform to dispatch maintenance personnel to perform maintenance on the current gas pipeline network.

In some embodiments, the processor may generate the operation instruction set through a plurality of manners based on the abnormality probability distribution.

In some embodiments, the processor may determine an abnormal condition combination with a highest probability of occurrence based on the abnormality probability distribution, and determine an operation instruction set corresponding to the abnormal condition combination by querying a second preset table. The second preset table may include a correspondence between abnormal condition combinations and operation instruction sets corresponding to the abnormal condition combinations. The second preset table may be pre-constructed by the processor and/or a technician based on historical data and/or empirical knowledge.

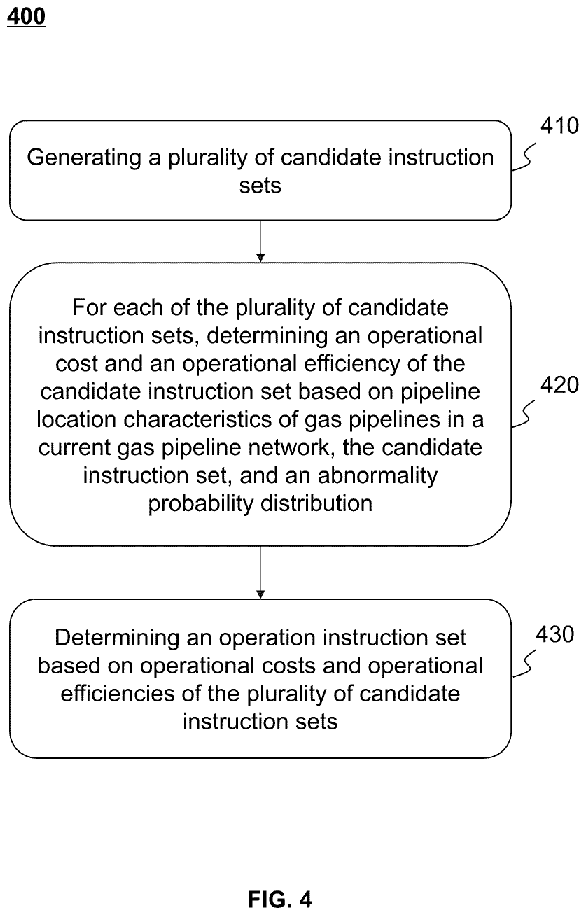

In some embodiments, the processor may generate a plurality of candidate instruction sets. For each of the plurality of candidate instruction set, the processor may determine an operational cost and an operational efficiency of the candidate instruction set based on pipeline location characteristics of gas pipelines in the current gas pipeline network, the candidate instruction set, and the abnormality probability distribution. Then the processor may determine the operation instruction set based on operational costs and operational efficiencies of the plurality of candidate instruction sets. More descriptions of the determination of the operation instruction set may be found in FIG. 4 and the related descriptions thereof.

In 250, generating a pressure adjustment instruction based on the pressure difference data matrix.

The pressure adjustment instruction refers to an instruction for adjusting pressure in gas pipelines. In some embodiments, the pressure adjustment instruction is sent to the gas equipment object platform to control a pressure adjustment device to regulate an abnormal gas pipeline in the current gas pipeline network. More descriptions regarding the pressure adjustment device may be found in related descriptions in FIG. 1.

In some embodiments, the processor may determine an abnormal gas pipeline and a time period corresponding to the abnormal pressure difference data based on the pressure difference data matrix, and further generate the corresponding pressure adjustment instruction to continuously control the abnormal gas pipeline such that the pressure difference of the abnormal gas pipeline remains within a normal pressure difference range during the time period corresponding to the abnormal pressure difference data.

In some embodiments of the present disclosure, by constructing the pressure difference data matrix based on pressure difference data of different gas pipelines during different time periods, whether abnormalities exist in the current gas pipeline network can be accurately determined, and the abnormality probability distribution of the gas pipeline network can be precisely identified. This enables the generation of corresponding operation instructions and pressure adjustment instructions, allowing timely and accurate assessment of pipeline network abnormalities and targeted operations such as regulation, inspection, and maintenance to ensure normal operation of the gas pipeline network.

FIG. 3 is a flowchart illustrating an exemplary process for determining an abnormality probability distribution according to some embodiments of the present disclosure. As shown in FIG. 3, process 300 may include the following operations. In some embodiments, process 300 may be executed by a processor in the gas company management platform 131.

In 310, obtaining flow rate data of a current gas pipeline network from a government safety supervision management platform.

The flow rate data refers to data related to gas flow rates within gas pipelines in the current gas pipeline network. For example, the flow rate data of the current gas pipeline network may include average flow rate data of each of the gas pipelines in the current gas pipeline network during different time periods.

The average flow rate data of a gas pipeline refers to an average value of gas flow rates in the gas pipeline over a time period. In some embodiments, the average flow rate data of a gas pipeline during a time period may be represented by an average value of instantaneous flow rate data collected at a plurality of time points within the time period. The instantaneous flow rate data of a gas pipeline refers to a volume of gas passing through a cross-section of the gas pipeline at a specific moment. The instantaneous flow rate data may be obtained through a flow sensor such as an ultrasonic flow meter, a turbine flow meter, or the like.

For example, the average flow rate data of a gas pipeline i may be represented as (Uᵢ₁, Uᵢ₂, . . . , Uᵢₙ), where Uᵢⱼ represents the average flow rate data of the gas pipeline i during a time period j (i=1, 2, . . . , m, j=1, 2, . . . , n). For definitions of m and n, refer to the related descriptions of the pressure difference data matrix in FIG. 2.

In some embodiments, the processor may obtain the flow rate data of each of the gas pipelines in the current gas pipeline network from the government safety supervision management platform through a government safety supervision sensor network platform. More descriptions regarding the above functional platforms may be found in FIG. 1 and the related descriptions thereof.

In 320, determining a flow characteristic graph of the current gas pipeline network based on the flow rate data.

The flow characteristic graph refers to a graph characterizing features related to the flow rate data of the current gas pipeline network. The flow characteristic graph may include a plurality of nodes and edges. In some embodiments, the processor may construct the flow characteristic graph based on connection relationships between gas pipelines in the current gas pipeline network and the flow rate data of each of the gas pipelines.

Each node in the flow characteristic graph corresponds to a gas pipeline in the current gas pipeline network. A node feature of a node may include average flow rate data of the gas pipeline corresponding to the node during different time periods.

In some embodiments, if two nodes in the flow characteristic graph correspond to connected gas pipelines, an edge exists between the two nodes. The edges in the flow characteristic graph are directed edges, with a direction pointing from an upstream gas pipeline to a downstream gas pipeline.

An edge feature of an edge in the flow characteristic graph may include an impact sequence representing impact levels of upstream nodes on downstream nodes.

The impact sequence refers to a sequence of impact levels corresponding to a plurality of time periods. The impact level corresponding to a time period represents a degree of influence of an upstream node on a downstream node during the time period.

In some embodiments, for an edge in the flow characteristic graph, the impact level corresponding to a time period may be calculated as a ratio of average flow rate data of the upstream node during the time period to a sum of average flow rate data of all upstream nodes of the downstream node.

For example, for an edge pointing from a gas pipeline a to a gas pipeline b, the gas pipeline a is an upstream node and the gas pipeline b is a downstream node. If there are three edges pointing to the gas pipeline b (with the other two edges originating from gas pipelines c and d), the impact level of the edge pointing from the gas pipeline a to the gas pipeline b during a time period j may be calculated as

$${X}_{abj} = \frac{{U}_{aj}}{{U}_{aj} + {U}_{cj +} {U}_{dj}} ,$$

where Uₐⱼ, U_{cj}, and U_{dj} represent the average flow rate data of gas pipelines a, c, and d during the time period j, respectively, and the gas pipelines a, c, and d are all upstream pipelines of the gas pipeline b.

In 330, determining a pressure difference characteristic graph of the current gas pipeline network based on the pressure difference data matrix and the flow rate data.

The pressure difference characteristic graph refers to a graph characterizing features related to the pressure difference data of the gas pipelines in the current gas pipeline network. The pressure difference characteristic graph may include a plurality of nodes and edges. In some embodiments, the processor may establish the pressure difference characteristic graph based on connection relationships between the gas pipelines in the current gas pipeline network, the flow rate data, and the pressure difference data matrix.

Nodes in the pressure difference characteristic graph are the same as the nodes in the flow characteristic graph. A node feature of a node in the pressure difference characteristic graph may include pressure difference data of a gas pipeline corresponding to the node during different time periods.

In some embodiments, the processor may directly extract the pressure difference data of the gas pipelines in the current gas pipeline network during different time periods from the pressure difference data matrix as node features of the nodes in the pressure difference characteristic graph.

Edges in the pressure difference characteristic graph are the same as the edges in the flow characteristic graph. An edge feature of an edge in the pressure difference characteristic graph may include a sensitivity sequence that represents sensitivity levels of upstream nodes to changes in downstream nodes.

The sensitivity sequence refers to a sequence composed of a plurality of sensitivity levels corresponding to a plurality of time periods. The sensitivity level corresponding to a time period indicates a degree of sensitivity to which a downstream node responds to changes of an upstream node during the time period. The higher the sensitivity level is, the greater the impact of the flow rate of the upstream gas pipeline on pressure of the downstream gas pipeline is.

In some embodiments, for an edge in the pressure difference characteristic graph, the sensitivity level corresponding a time period may be represented by a ratio of pressure difference data of the downstream node of the edge during the time period to average flow rate data of the upstream node of the edge during the time period.

For example, for the edge pointing from the gas pipeline a to the gas pipeline b where the gas pipeline a is an upstream node and the gas pipeline b is a downstream node, the sensitivity level of the edge during time period j may be expressed as R_{abj}=d_{bj}/Uₐⱼ, where Uₐⱼ represents the average flow rate data of the gas pipeline a during the time period j, and d_{bj} represents the pressure difference data of the gas pipeline b during the time period j.

In 340, determining an abnormality probability distribution of the current gas pipeline network based on the flow characteristic graph and the pressure difference characteristic graph.

In some embodiments, the processor may determine the abnormality probability distribution of the current gas pipeline network through an anomaly detection algorithm based on the flow characteristic graph and the pressure difference characteristic graph. The anomaly detection algorithm may include, but is not limited to, clustering algorithms, machine learning, and density statistics.

In some embodiments, the processor may determine a first probability distribution based on the flow characteristic graph, determine a second probability distribution based on the pressure difference characteristic graph, and determine the abnormality probability distribution of the current gas pipeline network based on the first probability distribution and the second probability distribution.

The first probability distribution refers to an abnormality probability distribution of nodes in the flow characteristic graph, indicating a distribution of abnormal conditions of gas pipelines in the flow characteristic graph. The first probability distribution may include a plurality of abnormal condition combinations in the flow characteristic graph and probabilities of occurrence corresponding to the abnormal condition combinations.

An abnormal condition combination in the flow characteristic graph refers to a combination of a plurality of first abnormal nodes and their corresponding abnormal conditions. More descriptions regarding the abnormal condition and the abnormal condition combination may be found in FIG. 2 and the relevant descriptions thereof.

A first abnormal node refers to an abnormal gas pipeline with abnormal conditions in the flow characteristic graph. In some embodiments, the processor may determine a node satisfying at least two preset conditions in a first preset condition group as a first abnormal node.

In some embodiments, each abnormal condition corresponds to a first preset condition group and a flow abnormality range.

The flow abnormality range refers to a range where average flow rate data falls outside a normal flow range, i.e., the flow abnormality range is contained in the complement of the normal flow range. Different abnormal conditions have different flow abnormality ranges. The determination of the normal flow range is similar to the determination of the normal pressure difference range, which may be found in operation 220 and the related descriptions above. The flow abnormality range may be determined by the processor and/or a technician based on historical data and/or empirical knowledge.

In some embodiments, the first preset condition group may include a first preset condition, a second preset condition, and a third preset condition. For a node under an abnormal condition: the first preset condition may be that, during a preset count of adjacent time periods, a plurality of average flow rate data values of the node remain within the flow abnormality range corresponding to the abnormal condition. The second preset condition may be that, during a most recent time period, average flow rate data of at least one downstream node of the node falls within the flow abnormality range corresponding to the abnormal condition. The third preset condition may be that, during the most recent time period, average flow rate data of an upstream node of an edge with a maximum impact level associated with the node falls within the flow abnormality range corresponding to the abnormal condition.

The adjacent time periods refer to time periods proximate to a current time period. For example, if the current time period is Period 10, adjacent time periods may include Periods 9 and 8 immediately preceding Period 10.

In some embodiments, the preset count of adjacent time periods in the first preset condition may be default-configured by the processor or predetermined by a technician based on experience.

In some embodiments, the processor may determine the preset count of adjacent time periods in the first preset condition based on an operation instruction sequence of the gas pipelines corresponding to the nodes in the flow characteristic graph.

The operation instruction sequence refers to a sequence composed of a plurality of time periods and operation instructions corresponding to the time periods. In some embodiments, the processor may determine the operation instruction sequence based on historical data.

In some embodiments, for a node in the flow characteristic graph, the processor may determine a historical time period corresponding to a most recent execution of a motion control instruction and a historical time period corresponding to a most recent execution of a maintenance instruction based on the operation instruction sequence. The processor may identify, from the two historical time periods, a historical time period closest to the current time period, and designate a count of time periods between the identified historical time period and the current time period as the preset count.

In some embodiments of the present disclosure, determining the preset count of adjacent time periods based on the operation instruction sequence ensures coverage of unmonitored periods following previous operation instructions (including the motion control instruction and/or the maintenance instruction), thereby avoiding misjudgments caused by data gaps and improving accuracy in identifying first abnormal nodes in the flow characteristic graph.

In some embodiments, one first abnormal node in the flow characteristic graph may have one or more abnormal conditions. If the first abnormal node has one abnormal condition, a probability of occurrence of the abnormal condition is 1. If the first abnormal node has a plurality of concurrent abnormal conditions, each condition has an equal probability. For example, if gas pipeline 1 in the flow characteristic graph has 10 abnormal conditions, each condition has a probability of 1/10.

Merely by way of example, the flow characteristic graph includes first abnormal node 1 (e.g., abnormal gas pipeline 1) and first abnormal node 2 (e.g., abnormal gas pipeline 2). If the first abnormal node 1 has abnormal conditions Y₁ and Y2, and the second abnormal node 2 has abnormal condition Y1, possible abnormal condition combinations may include W₁*={(L₁, Y₁), (L₂, Y₁)} and W₂*={(L₁, Y₂), (L₂, Y₁)}, where L₁ and L₂ represent the first abnormal nodes 1 and 2, respectively, and Y₁ and Y₂ represent abnormal conditions 1 and 2, respectively.

Correspondingly, the first probability distribution may be expressed as {P(W₁*)=p₁*, P(W₂)=p₂*}, where p₁* and p₂* represent probabilities of occurrence for the abnormal condition combinations W₁* and W₂* respectively. pi may be calculated as a product of the probability of the first abnormal node 1 having the abnormal condition Y₁ and the probability of the first abnormal node 2 having the abnormal condition Y₁, with similar calculations applying to other combinations.

The second probability distribution refers to an abnormality probability distribution of the nodes in the pressure difference characteristic graph, indicating a distribution of abnormal conditions of abnormal gas pipelines in the pressure difference characteristic graph. In some embodiments, the second probability distribution may include a plurality of abnormal condition combinations in the pressure difference characteristic graph and probabilities of occurrence corresponding to the abnormal condition combinations.

An abnormal condition combination in the pressure difference characteristic graph refers to a combination of a plurality of second abnormal nodes and their corresponding abnormal conditions.

A second abnormal node represents an abnormal gas pipeline with an abnormal condition in the pressure difference characteristic graph. In some embodiments, the processor may determine a node satisfying at least two preset conditions in a second preset condition group as a second abnormal node.

In some embodiments, each abnormal condition corresponds to a second preset condition group and an associated pressure difference abnormality range. That is to say, one abnormal condition may correspond to one flow abnormality range and one pressure difference abnormality range.

The pressure difference abnormality range refers to pressure difference data outside a normal pressure difference range, i.e., the pressure difference abnormality range is within the complement of the normal pressure difference range. Different abnormal conditions have different pressure difference abnormality ranges, which may be determined by the processor and/or a technician based on historical data and/or empirical knowledge. More descriptions regarding the normal pressure difference range and the pressure difference data may be found in the related descriptions of FIG. 2.

In some embodiments, the second preset condition group may include a fourth preset condition, a fifth preset condition, and a sixth preset condition. For a node under an abnormal condition, the fourth preset condition may require pressure difference data of the node during a plurality of adjacent time periods to remain within the pressure difference abnormality range corresponding to the abnormal condition. The fifth preset condition may require pressure difference data of at least one downstream node of the node during a most recent time period to be within the pressure difference abnormality range corresponding to the abnormal condition. The sixth preset condition may require pressure difference data of an upstream node corresponding to an edge with a maximum sensitivity level connected to the node during the most recent time period to be within the pressure difference abnormality range corresponding to the abnormal condition.

In some embodiments, a second abnormal node in the pressure difference characteristic graph may have one or more abnormal conditions. For the probabilities corresponding to the abnormal conditions of the second abnormal node, reference may be made to the probabilities corresponding to the abnormal conditions of the first abnormal node in the flow characteristic graph. Specifically, the manner for determining the second probability distribution based on the pressure difference characteristic graph is similar to the manner for determining the first probability distribution based on the flow characteristic graph. More descriptions may be found in related descriptions above.

In some embodiments, the processor may determine the abnormality probability distribution of the current gas pipeline network through weighted processing of the first probability distribution and the second probability distribution.

In some embodiments, a weighting relationship in the weighted processing may be determined based on the flow characteristic graph and the pressure difference characteristic graph. For example, for each of a plurality of time periods, the processor may determine a count nodes in the flow characteristic graph with average flow rate data within the flow abnormality range as a flow-abnormal node count in the time period, and determine a variance of flow-abnormal node counts in the plurality of time periods as a first variance. For each of the plurality of time periods, the processor may determine a count of nodes in the pressure difference characteristic graph with pressure difference data within the pressure difference abnormality range as pressure-difference-abnormal node count in the time period, and determine a variance of pressure-difference-abnormal node counts in the plurality of time periods as a second variance. Then the processor may determine the weighting relationship between the first probability distribution and the second probability distribution based on magnitudes of the first variance and the second variance.

Merely by way of example, if the first variance is greater than the second variance, indicating greater fluctuations in the pressure-difference-abnormal node counts compared to the flow-abnormal node counts across the time periods, a weight of the first probability distribution may be increased accordingly, i.e., the weight of the first probability distribution is greater than a weight of the second probability distribution. Conversely, if the first variance is less than (or equal to) the second variance, the weight of the first probability distribution may be reduced correspondingly, i.e., the weight of the first probability distribution is less than (or equal to) the weight of the second probability distribution.

In some embodiments of the present disclosure, by obtaining the first probability distribution based on the flow characteristic graph and the second probability distribution based on the pressure difference characteristic graph, then assigning accurate weights based on relative magnitudes of the variances of the pressure-difference-abnormal node counts and the flow-abnormal node counts across time periods, the abnormality probability distribution of the current gas pipeline network can be determined with improved accuracy.

In some embodiments of the present disclosure, the flow characteristic graph and the pressure difference characteristic graph are obtained based on the flow rate data and the pressure difference data matrix of the current gas pipeline network, then the abnormality probability distribution is determined, which effectively considers both flow conditions and pressure difference variations within the gas pipelines in the current gas pipeline network, thereby reducing misjudgments of abnormal conditions and improving identification accuracy of abnormal pipelines.

FIG. 4 is a flowchart illustrating an exemplary process for determining an operation instruction set according to some embodiments of the present disclosure. As shown in FIG. 4, process 400 includes operations 410-430. In some embodiments, process 400 may be executed by the gas company management platform 131, e.g., by a processor within the gas company management platform 131.

In 410, generating a plurality of candidate instruction sets.

A candidate instruction set refers to a collection of a plurality of candidate instructions, which may be used as an operation instruction set.

In some embodiments, the processor may randomly combine one or more candidate instructions to form one or more candidate instruction sets.

A candidate instruction refers to an operation instruction intended for selection. A candidate instruction set may include one or more of a candidate monitoring regulation instruction, a candidate motion control instruction, a candidate maintenance instruction, and a candidate reporting instruction. In some embodiments, candidate instructions may be randomly generated by the processor or manually configured by a technician based on experience.

Further details about these instructions may be found in the related descriptions of FIG. 2.

In 420, for a candidate instruction among the plurality of candidate instruction sets, determining an operational cost and an operational efficiency of the candidate instruction set based on pipeline location characteristics of gas pipelines in a current gas pipeline network, the candidate instruction set, and an abnormality probability distribution.

The pipeline location characteristic of a gas pipeline refers to a positional attribute of the gas pipeline, such as a geographical location of the gas pipeline, etc.

In some embodiments, the processor may directly retrieve pre-uploaded geographical locations of the gas pipelines in the current gas pipeline network.

The operational cost of a candidate instruction set refers to resources required to execute the candidate instruction set, including but not limited to: a total count of maintenance personnel and/or devices, a total working duration, and aggregate distances between the gas pipelines and an operational hub.

The maintenance personnel may include staff for maintaining the gas pipelines, and the devices may include pipeline inspection devices. In some embodiments, the processor may determine a count of devices based on a motion control instruction and a count of maintenance personnel based on a maintenance instruction, thereby determining the total count of maintenance personnel and/or devices.

The total working duration refers to a sum of cumulative maintenance durations by the maintenance personnel and/or inspection durations by the devices. In some embodiments, the processor may determine an average value of a plurality of historical working durations as the total working duration.

The operational hub refers to a location where the maintenance personnel and/or the devices are dispatched from or gathered, and may include a maintenance center and an inspection center. The distances between the gas pipelines and the operational hub may be determined by the processor based on geographical locations of the gas pipelines and the operational hub.

In some embodiments, the processor may determine the operational cost by performing a weighted summation based on the total count of maintenance personnel and/or devices, the total working duration, and the aggregate distances. Weights for the weighted summation may be preset by default or configured by a technician.

The operational efficiency of a candidate instruction set refers to an ability of the candidate instruction set to detect abnormalities and/or resolve risks in the gas pipeline network.

In some embodiments, the processor may determine the operational efficiency based on an operational coefficient, a standard instruction set, and the candidate instruction set. Each abnormal condition combination in the abnormality probability distribution corresponds to a standard instruction set. The standard instruction set and the operational coefficient may be preset by the processor or predefined by a technician based on experience.

For example, for an abnormal condition combination, the processor may determine a difference between the standard instruction set corresponding to the abnormal condition combination and a candidate instruction set, and designate a ratio of the operational coefficient to the difference as the operational efficiency of the candidate instruction set.

In some embodiments, the difference between the standard instruction set and the candidate instruction set may be represented by a vector distance. For example, for a gas pipeline, the processor may determine a vector distance between a standard operation instruction corresponding to the gas pipeline in the standard instruction set and a candidate operation instruction corresponding to the gas pipeline in the candidate instruction set. Then the processor may determine an average value of vector distances for all gas pipelines in the current gas pipeline network as the difference between the standard instruction set and the candidate instruction set. The vector distance refers to a distance between a standard vector corresponding to the standard operation instruction and a candidate vector corresponding to the candidate operation instruction, such as a Euclidean distance. Element of the standard vector may include: a monitoring frequency and a standard count of additional pipeline monitoring devices in a standard monitoring regulation instruction, a preset frequency in a standard motion control instruction, a quantified value of a standard reporting instruction (a value of 1 indicates that the standard reporting instruction exists, and a value 0 indicates no standard reporting instruction), and gas pipeline geographical locations and an allocated count of maintenance personnel in a standard maintenance instruction. Elements of the candidate vector are defined in the same way.

In some embodiments, for an abnormal condition combination, the processor may determine a product of the probability of occurrence corresponding to the abnormal condition combination and the operational efficiency, then sum products for all abnormal condition combinations included in the candidate instruction set to determine the operational efficiency of the candidate instruction set.

In 430, determining the operation instruction set based on operational costs and operational efficiencies of the plurality of candidate instruction sets.

In some embodiments, for each of the plurality of candidate instruction sets, the processor may perform a weighted summation on the operational cost and the operational efficiency of the candidate instruction set, and select a candidate instruction set with a largest weighted summation value as the operation instruction set. A weighting coefficient for the operational cost is negative, and weights for the operational cost and the operational efficiency may be preset by the processor or predefined by a technician based on experience.

In some embodiments of the present disclosure, by evaluating the operational costs and the operational efficiencies of the candidate instruction sets, the operation instruction set can be accurately and rapidly determined based on the candidate instructions, thereby enhancing safety management of the gas pipeline network.

In some embodiments, the operation instruction set may further include operation instruction sequences for gas pipelines in the current gas pipeline network during different time periods. The processor may determine the operation instruction set through an evaluation model based on pipeline location characteristics of the gas pipelines in the current gas pipeline network and the abnormality probability distribution.

More descriptions regarding the operation instruction set, the current gas pipeline network, the different time periods, the operation instruction sequences, the pipeline location characteristics, and the abnormality probability distribution may be found in FIGS. 2-4 and the related descriptions thereof.

The evaluation model refers to a model configured to determine the operation instruction set. In some embodiments, the evaluation model may be a machine learning model, such as a Deep Neural Network (DNN), a Graph Neural Network (GNN), or the like.

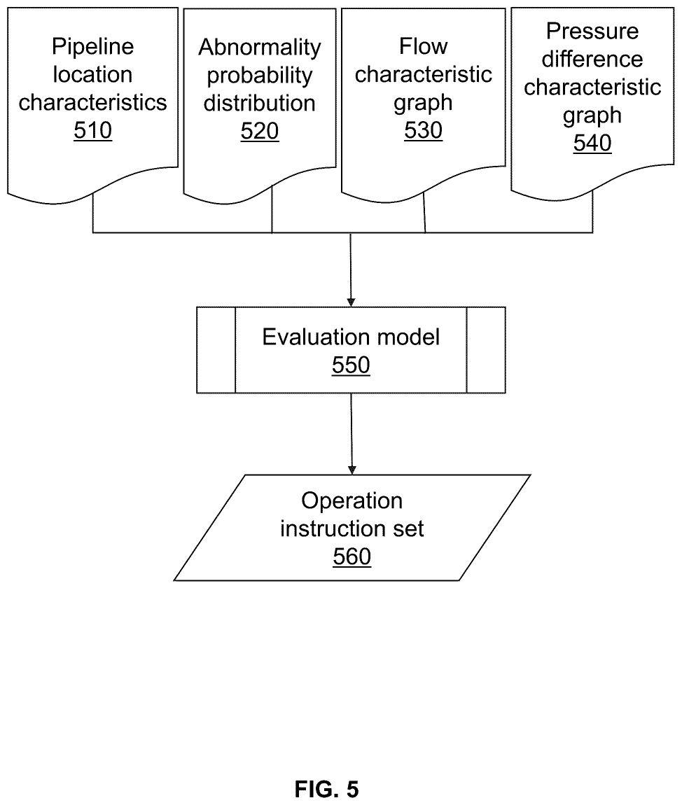

In some embodiments, as shown in FIG. 5, an input of the evaluation model 550 may include pipeline location characteristics 510 and an abnormality probability distribution 520, and an output of the evaluation model 550 may be an operation instruction set 560.

In some embodiments, the evaluation model may be trained in a plurality of ways. For example, the evaluation model may be trained using training samples with training labels. A training sample set for training the evaluation model may include sample pipeline location characteristics of sample gas pipelines and a sample abnormality probability distribution. The training label corresponding to the training sample set is an actual operation instruction set with optimal operational performance.

In some embodiments, the processor may obtain a plurality of training sample sets from historical data, where historical pipeline location characteristics of gas pipelines and a historical abnormality probability distribution in a historical gas pipeline network may form a training sample set. The processor may construct a plurality of historical vectors based on the plurality of training sample sets, wherein a historical vector includes historical pipeline location characteristics and historical abnormal conditions. The processor may cluster the plurality of historical vectors to determine one or more clusters. For each of the one or more clusters, the processor may designate a historical actual operation instruction set with optimal operational performance from a plurality of historical actual operation instruction sets corresponding to training samples in the cluster as the training label for all training samples in the cluster. Clustering manners include but are not limited to K-means clustering, mean-shift clustering, or the like. The optimal operational performance refers to that over a plurality of time periods after executing a historical actual operation instruction set, historical pressure difference data of all historical gas pipelines in the historical gas pipeline network corresponding to the historical actual operation instruction set remain within a normal pressure difference range with minimal fluctuations in historical pressure difference data.

More descriptions regarding the abnormal conditions, the pressure difference data, and the normal pressure difference range may be found in FIG. 2 and the related descriptions thereof.

In some embodiments, the processor may perform multi-iteration training on an initial evaluation model based on a plurality of groups of training samples with training labels. An iteration includes: inputting a group of training samples with training labels into an initial evaluation model, determining a loss function value based on the training labels and an output result of the initial evaluation model, and iteratively updating parameters of the initial evaluation model based on the loss function value. A plurality of iterations may be executed until an iteration condition is met. The training of the initial evaluation model is completed, and a trained evaluation model is obtained. Iteration manners may include a gradient descent technique, or the like. The iteration condition may include convergence of the loss function, the iterations reaching a preset count threshold, the loss function value being less than a preset threshold, or the like, or any combinations thereof.

In some embodiments, as shown in FIG. 5, the input of the evaluation model may further include a flow characteristic graph 530 and a pressure difference characteristic graph 540.

More descriptions regarding the flow characteristic graph and the pressure difference characteristic graph may be found in FIG. 3 and the related descriptions thereof.

In some embodiments, the training samples for training the evaluation model may further include a sample flow characteristic graph and a sample pressure difference characteristic graph, which may be obtained based on historical data.

In some embodiments, the processor may train the evaluation model using training samples including the sample flow characteristic graph, the sample pressure difference characteristic graph, the sample pipeline location characteristics, and the sample abnormality probability distribution. More descriptions regarding the training of the evaluation model may be found in the preceding related descriptions.

In some embodiments of the present disclosure, incorporating the flow characteristic graph and the pressure difference characteristic graph as inputs to the evaluation model can improve accuracy in determining the operation instruction set through the evaluation model.

In some embodiments, the processor may update a learning rate of the evaluation model based on a decay factor in response to completing a preset count of training iterations for the evaluation model.

The preset count of training iterations refers to a pre-defined training iteration count, such as a preset count of iterations.

In some embodiments, the processor may determine the preset count of training iterations based on a complexity level of the pressure difference characteristic graph.

A higher complexity level of the pressure difference characteristic graph indicates more complex connection patterns among the gas pipelines in the current gas pipeline network, implying higher potential instability and greater information content in the training samples. Therefore, the complexity level of the pressure difference characteristic graph may be positively correlated with the preset count of training iterations. In other words, the higher the complexity level of the pressure difference characteristic graph is, the larger the preset count of training iterations may be set, so as to delay learning rate decay to enable the evaluation model to accurately learn data characteristics from the training samples.

The complexity level of the pressure difference characteristic graph refers to a degree of structural intricacy of the pressure difference characteristic graph. In some embodiments, the complexity level may be represented by a numerical value from 0 to 10, where a larger value indicates a higher complexity level.

In some embodiments, the processor may determine a pipeline in-degree and a pipeline out-degree of each node in the pressure difference characteristic graph, determine a variance of pipeline in-degrees of all nodes and a variance of pipeline out-degrees of all nodes, and determine an average of these two variances as the complexity level of the pressure difference characteristic graph. The pipeline in-degree of a node refers to a count of pipelines directed into the node, and the pipeline out-degree of a node refers to a count of pipelines directed out of the node. The pipeline in-degree and the pipeline out-degree may be obtained by the processor based on the pressure difference characteristic graph.

The decay factor is a parameter for decaying the learning rate of the evaluation model, represented by a value between 0 and 1. In some embodiments, the decay factor may be preset by the processor or configured by a technician based on empirical knowledge.

The learning rate is a parameter for controlling updates of the evaluation model, such as a step size in gradient descent during iterative training of the evaluation model. In some embodiments, after completing the preset count of training iterations, the processor may update the learning rate based on the learning rate and the decay factor. For example, the processor may multiply the learning rate with the decay factor to obtain a new learning rate.

In some embodiments of the present disclosure, determining the preset count of training iterations based on the complexity level of the pressure difference characteristic graph and updating the learning rate based on the decay factor after completing the preset count of training iterations helps the model converge better to an optimal solution. This approach can avoid oscillations or non-convergence during model training, ensure thorough learning, and facilitate accurate acquisition of the operation instruction set.

In some embodiments of the present disclosure, determining the operation instruction set through the evaluation model based on pipeline location characteristics and the abnormality probability distribution leverages the learning capabilities of machine learning models to accurately assess operation instructions, thereby improving accuracy in abnormality maintenance of gas pipelines.

One or more embodiments of the present disclosure provide a non-transitory computer-readable storage medium storing computer instructions. When a computer reads the computer instructions from the storage medium, the computer executes the method for smart gas pipeline pressure difference safety monitoring described in the present disclosure.

The basic concepts have been described above, and it will be apparent to those skilled in the art that the foregoing detailed disclosure is intended as an example only and does not constitute a limitation of the present disclosure. Although not expressly stated herein, a person skilled in the art may make various modifications, improvements, and amendments to the present disclosure. Such modifications, improvements, and amendments are suggested in the present disclosure, so such modifications, improvements, and amendments remain within the spirit and scope of the exemplary embodiments of the present disclosure.

Also, the present disclosure uses specific words to describe the embodiments of the present disclosure. For example, “an embodiment”, “one embodiment”, and/or “some embodiments” means a feature, structure, or characteristic related to at least one embodiment of the present disclosure. Accordingly, it should be emphasized and noted that “an embodiment”, “one embodiment” or “an alternative embodiment” referred to two or more times in different places in the present disclosure do not necessarily refer to the same embodiment. In addition, certain features, structures, or characteristics of one or more embodiments of the present disclosure may be suitably combined.

Furthermore, unless explicitly stated in the claims, the order of processing elements and sequences, the use of numerical and alphabetic characters, or the use of other names in the present disclosure are not intended to limit the sequence of the processes and methods described herein. While various examples have been discussed in the present disclosure to illustrate certain inventive embodiments that are currently considered useful, it should be understood that such details are provided for illustrative purposes and that the appended claims are not limited to the disclosed embodiments. Instead, the claims are intended to cover all modifications and equivalent combinations that fall within the spirit and scope of the embodiments described in the present disclosure. For example, while the system components described above may be implemented through hardware devices, they may also be achieved solely through software solutions, such as by installing the described system on existing servers or mobile devices.

Similarly, it should be noted that in order to simplify the presentation of the present disclosure, and thereby aid in the understanding of one or more embodiments, the preceding description of embodiments of the present disclosure sometimes incorporates a variety of features into a single embodiment, accompanying drawings, or description thereof. However, this manner of disclosure does not imply that the subject matter of the present disclosure requires more features than those mentioned in the claims. Rather, claimed subject matter may lie in less than all features of a single foregoing disclosed embodiment.

Some embodiments use numbers to describe the count of components, and attributes, and it should be understood that such numbers used in the description of the embodiments are modified in some examples by the modifiers “about”, “approximately”, or “generally”. Unless otherwise stated, “about”, “approximately” or “generally” indicates that a variation of ±20% is permitted. Accordingly, in some embodiments, the numerical parameters used in the present disclosure and claims are approximations, which may change depending on the desired characteristics of the individual embodiment. In some embodiments, the numeric parameters should be considered with the specified significant figures and be rounded to a general number of decimal places. Although the numerical domains and parameters configured to confirm the breadth of their ranges in some embodiments of the present disclosure are approximations, in specific embodiments such values are set as precisely as possible within the feasible range.

With respect to each patent, patent application, patent application disclosure, and other material, such as articles, books, manuals, publications, documents, etc., cited in the present disclosure, the entire contents thereof are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and those described in the present disclosure, the descriptions, definitions, and/or use of terminology in the present disclosure shall prevail.

In closing, it should be understood that the embodiments described in the present disclosure are intended only to illustrate the principles of the embodiments of the present disclosure. Other deformations may also fall within the scope of the present disclosure. Thus, by way of example and not limitation, alternative configurations of embodiments of the present disclosure may be considered consistent with the teachings of the present disclosure. Accordingly, the embodiments of the present disclosure are not limited to the embodiments expressly presented and described herein.

What is claimed is:

1. An Internet of Things (IoT) system for smart gas pipeline pressure difference safety monitoring, comprising a government safety supervision management platform, a government safety supervision sensor network platform, a government safety supervision object platform, a gas company sensor network platform, a gas equipment object platform, and a gas maintenance object platform, the government safety supervision object platform including a gas company management platform; wherein
the gas company management platform is configured to:
obtain a pressure difference data matrix of a current gas pipeline network from the gas equipment object platform, wherein the pressure difference data matrix includes pressure difference data of gas pipelines in the current gas pipeline network during different time periods;
determine an abnormality judgment result for the current gas pipeline network based on the pressure difference data matrix;
in response to determining that the abnormality judgment result indicates an abnormality, determine an abnormality probability distribution of the current gas pipeline network based on the pressure difference data matrix;
generate an operation instruction set based on the abnormality probability distribution, wherein the operation instruction set includes operation instructions corresponding to the gas pipelines, and the operation instructions include at least one of a monitoring regulation instruction, a motion control instruction, a reporting instruction, and a maintenance instruction; wherein
the monitoring regulation instruction is sent to the gas equipment object platform to adjust a monitoring frequency of a pipeline monitoring device;
the motion control instructions is sent to the gas equipment object platform to instruct a pipeline inspection device to inspect one or more target gas pipelines at a preset frequency;
the reporting instruction is sent to the government safety supervision management platform to receive and record an abnormal condition of the current gas pipeline network;
the maintenance instruction is sent to the gas maintenance object platform to dispatch maintenance personnel to perform maintenance on the current gas pipeline network; and
generate a pressure adjustment instruction based on the pressure difference data matrix, and sent the pressure adjustment instruction to the gas equipment object platform to control a pressure adjustment device to regulate an abnormal gas pipeline in the current gas pipeline network.

2. The IoT system of claim 1, wherein the gas company management platform is further configured to:
in response to determining that a count of abnormal gas pipelines in the pressure difference data matrix exceeds a first preset threshold, determine that the abnormality judgment result indicates an abnormality,
wherein the first preset threshold is related to a count of abnormality occurrences in the current gas pipeline network during a historical time period.

3. The IoT system of claim 1, wherein the gas company management platform is further configured to:
obtain flow rate data of the current gas pipeline network from the government safety supervision management platform;
determine a flow characteristic graph of the current gas pipeline network based on the flow rate data;
determine a pressure difference characteristic graph of the current gas pipeline network based on the pressure difference data matrix and the flow rate data; and
determine the abnormality probability distribution of the current gas pipeline network based on the flow characteristic graph and the pressure difference characteristic graph.

4. The IoT system of claim 3, wherein the gas company management platform is further configured to:
determine a first probability distribution based on the flow characteristic graph;
determine a second probability distribution based on the pressure difference characteristic graph; and
determine the abnormality probability distribution of the current gas pipeline network based on the first probability distribution and the second probability distribution.

5. The IoT system of claim 1, wherein the gas company management platform is further configured to:
generate a plurality of candidate instruction sets;
for a candidate instruction among the plurality of candidate instruction sets, determine an operational cost and an operational efficiency of the candidate instruction set based on pipeline location characteristics of the gas pipelines in the current gas pipeline network, the candidate instruction set, and the abnormality probability distribution; and
determine the operation instruction set based on operational costs and operational efficiencies of the plurality of candidate instruction sets.

6. The IoT system of claim 1, wherein the operation instruction set further includes operation instruction sequences for the gas pipelines in the current gas pipeline network during different time periods, and the gas company management platform is further configured to:
determine the operation instruction set through an evaluation model based on pipeline location characteristics of the gas pipelines in the current gas pipeline network and the abnormality probability distribution, wherein the evaluation model is a machine learning model.

7. The IoT system of claim 6, wherein an input of the evaluation model includes a flow characteristic graph and a pressure difference characteristic graph.

8. The IoT system of claim 7, wherein the evaluation model is obtained through multi-iteration training, and the gas company management platform is further configured to:
update a learning rate of the evaluation model based on a decay factor in response to completing a preset count of training iterations for the evaluation model, wherein the preset count of training iterations is determined based on a complexity level of the pressure difference characteristic graph.

9. A method for smart gas pipeline pressure difference safety monitoring, implemented by a gas company management platform of an Internet of Things (IoT) system for smart gas pipeline pressure difference safety monitoring, the IoT system comprising a government safety supervision management platform, a government safety supervision sensor network platform, a government safety supervision object platform, a gas company sensor network platform, a gas equipment object platform, and a gas maintenance object platform, and the method comprising:
obtaining a pressure difference data matrix of a current gas pipeline network from the gas equipment object platform, wherein the pressure difference data matrix includes pressure difference data of gas pipelines in the current gas pipeline network during different time periods;
determining an abnormality judgment result of the current gas pipeline network based on the pressure difference data matrix;
in response to determining that the abnormality judgment result indicates an abnormality, determine an abnormality probability distribution of the current gas pipeline network based on the pressure difference data matrix;
generating an operation instruction set based on the abnormality probability distribution, wherein the operation instruction set includes operation instructions corresponding to the gas pipelines, and the operation instructions include at least one of a monitoring regulation instruction, a motion control instruction, a reporting instruction, and a maintenance instruction; wherein
the monitoring regulation instruction is sent to the gas equipment object platform to adjust a monitoring frequency of a pipeline monitoring device;
the motion control instructions is sent to the gas equipment object platform to instruct a pipeline inspection device to inspect one or more target gas pipelines at a preset frequency;
the reporting instruction is sent to the government safety supervision management platform to receive and record an abnormal condition of the current gas pipeline network;
the maintenance instruction is sent to the gas maintenance object platform to dispatch maintenance personnel to perform maintenance on the current gas pipeline network; and
generating a pressure adjustment instruction based on the pressure difference data matrix, and sending the pressure adjustment instruction to the gas equipment object platform to control a pressure adjustment device to regulate an abnormal gas pipeline in the current gas pipeline network.

10. The method of claim 9, wherein the determining an abnormality judgment result of the current gas pipeline network based on the pressure difference data matrix includes:
in response to determining that a count of abnormal gas pipelines in the pressure difference data matrix exceeds a first preset threshold, determining that the abnormality judgment result indicates an abnormality, wherein the first preset threshold is related to a count of abnormality occurrences in the current gas pipeline network during a historical time period.

11. The method of claim 9, wherein the determining an abnormality probability distribution of the current gas pipeline network based on the pressure difference data matrix includes:
obtaining flow rate data of the current gas pipeline network from the government safety supervision management platform;
determining a flow characteristic graph of the current gas pipeline network based on the flow rate data;
determining a pressure difference characteristic graph of the current gas pipeline network based on the pressure difference data matrix and the flow rate data; and
determining the abnormality probability distribution of the current gas pipeline network based on the flow characteristic graph and the pressure difference characteristic graph.

12. The method of claim 11, wherein the determining the abnormality probability distribution of the current gas pipeline network based on the flow characteristic graph and the pressure difference characteristic graph includes:
determining a first probability distribution based on the flow characteristic graph;
determining a second probability distribution based on the pressure difference characteristic graph; and
determining the abnormality probability distribution of the current gas pipeline network based on the first probability distribution and the second probability distribution.

13. The method of claim 9, wherein the generating an operation instruction set based on the abnormality probability distribution includes:
generating a plurality of candidate instruction sets;
for a candidate instruction among the plurality of candidate instruction sets, determining an operational cost and an operational efficiency of the candidate instruction set based on pipeline location characteristics of the gas pipelines in the current gas pipeline network, the candidate instruction set, and the abnormality probability distribution; and
determining the operation instruction set based on operational costs and operational efficiencies of the plurality of candidate instruction sets.

14. The method of claim 9, wherein the operation instruction set further includes operation instruction sequences for the gas pipelines in the current gas pipeline network during different time periods, and the generating an operation instruction set based on the abnormality probability distribution further includes:
determining the operation instruction set through an evaluation model based on the pipeline location characteristics of the gas pipelines in the current gas pipeline network and the abnormality probability distribution, wherein the evaluation model is a machine learning model.

15. The method of claim 14, wherein an input of the evaluation model includes a flow characteristic graph and a pressure difference characteristic graph.

16. The method of claim 15, wherein the evaluation model is obtained through multi-iteration training, and the method further comprises:
updating a learning rate of the evaluation model based on a decay factor in response to completing a preset count of training iterations for the evaluation model, wherein the preset count of training iterations is determined based on a complexity level of the pressure difference characteristic graph.

17. A non-transitory computer-readable storage medium storing computer instructions, wherein when reading the computer instructions from the storage medium, a computer executes a method for smart gas pipeline pressure difference safety monitoring, implemented by a gas company management platform of an Internet of Things (IoT) system for smart gas pipeline pressure difference safety monitoring, the IoT system comprising a government safety supervision management platform, a government safety supervision sensor network platform, a government safety supervision object platform, a gas company sensor network platform, a gas equipment object platform, and a gas maintenance object platform, and the method comprising:
obtaining a pressure difference data matrix of a current gas pipeline network from the gas equipment object platform, wherein the pressure difference data matrix includes pressure difference data of gas pipelines in the current gas pipeline network during different time periods;
determining an abnormality judgment result of the current gas pipeline network based on the pressure difference data matrix;
in response to determining that the abnormality judgment result indicates an abnormality, determine an abnormality probability distribution of the current gas pipeline network based on the pressure difference data matrix;
generating an operation instruction set based on the abnormality probability distribution, wherein the operation instruction set includes operation instructions corresponding to the gas pipelines, and the operation instructions include at least one of a monitoring regulation instruction, a motion control instruction, a reporting instruction, and a maintenance instruction; wherein
the monitoring regulation instruction is sent to the gas equipment object platform to adjust a monitoring frequency of a pipeline monitoring device;
the motion control instructions is sent to the gas equipment object platform to instruct a pipeline inspection device to inspect one or more target gas pipelines at a preset frequency;
the reporting instruction is sent to the government safety supervision management platform to receive and record an abnormal condition of the current gas pipeline network;
the maintenance instruction is sent to the gas maintenance object platform to dispatch maintenance personnel to perform maintenance on the current gas pipeline network; and
generating a pressure adjustment instruction based on the pressure difference data matrix, and sending the pressure adjustment instruction to the gas equipment object platform to control a pressure adjustment device to regulate an abnormal gas pipeline in the current gas pipeline network.
